(19) United States
(12) Patent Application Publication
(10) Pub. No.: US 2004/0065069 A1
(43) Pub. Date: Apr. 8, 2004

(54) Crop harvesting machine with recoil action on impact with an obstacle

(76) Inventors: James Thomas Dunn, Winnipeg (CA); Geoffrey U. Snider, Winnipeg (CA)

Correspondence Address: ADE & COMPANY, 1700-360 MAIN STREET, WINNIPEG, MB, R3C3Z3, CA

(21) Appl. No.: 10/262,663

(22) Filed: Oct. 2, 2002

(51) Int. Cl. A01D 75/18

(52) U.S. Cl. 56/10.4

(57) ABSTRACT

A crop harvesting machine includes a crop harvesting header mounted on a transport vehicle for carrying the header across the ground with at least one upper connecting link extending from the vehicle frame to an upper frame member and two support arms each extending from a front end at the header to a rear end pivotally mounted on the vehicle frame and arranged at a height below the upper link. Each support arm has a respective float spring connected thereto at a pivot thereon forwardly of the rear end and extending therefrom to the vehicle frame for applying a lifting force on the support arm. Each support arm has a pivot connection at the rear end defined by a pivotal link connected at a forward end to the frame by a resilient bushing and at a rear end by a similar bushing to the rear end of the support arm. The pivotal link is inclined upwardly and rearwardly in the normal operating position and thus pivots downwardly and rearwardly on an impact so as to absorb the impact on the crop cutter and tending to cause pivotal movement of the support arm relative to the pivot connection to the float spring to effect lifting movement of the cutter relative to the ground.

This invention relates to a crop harvesting machine including a header mounted on a vehicle.

### BACKGROUND OF THE INVENTION

It is well known to provide a tractor arrangement for transport of a header across the ground for harvesting of a crop standing on the ground. Various types of header are available for this purpose depending upon the type and quality of crop.

Many headers of this type are arranged so that the cutting arrangement is as close as possible to the ground giving the possibility of a damaging impact with obstacles on the ground, primarily rocks. It is therefore desirable to provide in some cases the possibility of a recoil action which allows the header to move rearwardly relative to the tractor upon an impact thus taking up some of the force to reduce the possibility of damage.

One arrangement which allows a recoil action has a header which is in effect suspended in a pendulum manner from a suitable support above the header on the tractor so that impact allows the header to swing rearwardly about a pivot axis above the header. An example of such an arrangement is shown in the brochure by Vermeer of their “Discpro” mower conditioner. However the location of the pivot axis above the header is inconvenient and makes the design difficult or impossible for headers that include a reel, as is required in many end uses.

### SUMMARY OF THE INVENTION

It is one object of the present invention to provide an improved harvesting machine which provides an improved link between the header and the vehicle frame.

According to a first aspect of the invention there is provided a crop harvesting machine comprising:

a crop harvesting header having:

a header frame structure arranged for movement in a direction of working movement across ground carrying a crop to be harvested;

a crop cutter arranged across the header frame structure for cutting the crop;

the header frame structure including an upper frame member and a plurality of lower frame elements arranged such that an impact on the crop cutter as the header moves forwardly across the ground tends to move the lower frame elements rearwardly;

a transport vehicle for carrying the header across the ground having:

a vehicle frame;

ground wheels for supporting the frame in transport across the ground;

at least one upper connecting link extending from the vehicle frame to the upper frame member;

and a connection between the vehicle frame and the lower frame elements for providing a lifting force on the header frame, the connection including at least one support arm at a height below the upper link extending from the vehicle frame generally forwardly to the lower frame elements;

the connection between the vehicle frame and the lower frame elements being arranged such that an impact on the crop cutter tending to move the lower frame elements rearwardly is absorbed by rearward movement of the header relative to the vehicle and also causes lifting movement of the cutter relative to the ground.

The arrangement described herein is primarily designed for use with a header of the type using a sickle knife as the cutting system since such sickle knifes are particularly prone to damage on impact. However the present invention is not intended to be limited to such cutting devices and the header can use other cutting devices well known to one skilled in the art of various different types.

The vehicle as described herein after is generally of the type conventionally used as a swather tractor which has two front wheels each mounted on a respective leg and driven hydraulically so the leg provides a suitable support for the forwardly extending lower lift arm or support arm. However other arrangements of vehicle can be used and the linkage between the support arm and the tractor frame as described in detail herein after, can be utilised on other arrangements of tractor vehicle.

Preferably the connection is arranged such that the rearward movement of the header relative to the vehicle causes said lifting movement of the cutter relative to the ground.

Preferably the connection includes a linkage which is arranged such that the rearward movement of the linkage causes said lifting movement of the cutter relative to the ground.

Preferably the linkage is provided between the at least one support arm and the vehicle frame.

Preferably the at least one support arm is mounted on the vehicle frame for pivotal movement upwardly and downwardly about a horizontal pivot axis and wherein there is provided a lift link pivotally connected between the support arm and the vehicle frame for pivoting the at least one support arm in a direction tending to lift a forward end of the at least one support arm and therefore the header carried thereon.

Preferably the connection includes a linkage which is arranged such that the rearward movement of the header causes pivotal movement of the at least one support arm generating said lifting movement of the cutter relative to the ground.

Preferably the linkage is provided between the at least one support arm and the vehicle frame tending to pivot the support arm about the lift link.

Preferably the at least one support arm is pivotally mounted on the vehicle frame at a rear end of the at least one support arm and wherein the lift link is arranged in front of the rear end.

Preferably the lift link is a float spring. The spring force can be provided by any form of spring including hydraulic cylinders, coil springs or leaf springs.

Preferably the linkage comprises a pivotal link pivotally connected at one end to the vehicle frame and pivotally connected at the other end to the support arm and arranged such that rearward movement of the support arm is taken up by pivotal movement of the link which causes pivotal movement of the support arm.

Preferably the pivotal link is pivotally connected to the vehicle frame by a first resilient bushing capable of angularly limited pivotal movement and to the support arm by a second resilient bushing capable of angularly limited pivotal movement and where the pivotal movement of the support arm relative to the vehicle frame is taken up partly by each of the first and second resilient bushings.

Preferably the pivotal link is arranged such that, prior to impact forces moving the support arm rearwardly, the link is arranged to extend from the vehicle frame upwardly and rearwardly to the support arm such that rearward movement of the support arm is taken up by rearward movement of the rear end of the link which causes downward movement of the rear end of the link causing downward movement of the rear end of the support arm.

According to a second aspect of the invention there is provided a crop harvesting machine comprising:

a crop harvesting header having:

a header frame structure arranged for movement in a direction of working movement across ground carrying a crop to be harvested;

a crop cutter arranged across the header frame structure for cutting the crop;

the header frame structure including an upper frame member and a plurality of lower frame elements arranged such that an impact on the crop cutter as the header moves forwardly across the ground tends to move the lower frame elements rearwardly;

a transport vehicle for carrying the header across the ground having:

a vehicle frame;

ground wheels for supporting the frame in transport across the ground;

at least one upper connecting link extending from the vehicle frame to the upper frame member;

and two support arms each extending from a front end at the header to a rear end pivotally mounted on the vehicle frame and arranged at a height below the upper link extending from the vehicle frame generally forwardly to the lower frame elements;

each support arm having a respective float spring connected thereto at a pivot thereon forwardly of the rear end and extending therefrom to the vehicle frame for applying a lifting force on the support arm;

each support arm having a pivot connection at the rear end arranged such that an impact on the crop cutter tending to move the lower frame elements rearwardly is absorbed by rearward movement of the a support arm relative to the vehicle which rearward movement causes pivotal movement of the support arm relative to the pivot connection to the float spring to effect lifting movement of the cutter relative to the ground.

According to a third aspect of the invention there is provided a crop harvesting machine comprising:

a crop harvesting header having:

a header frame structure arranged for movement in a direction of working movement across ground carrying a crop to be harvested;

a crop cutter arranged across the header frame structure for cutting the crop;

the header frame structure including an upper frame member and a plurality of lower frame elements arranged such that an impact on the crop cutter as the header moves forwardly across the ground tends to move the lower frame elements rearwardly;

a transport vehicle for carrying the header across the ground having:

a vehicle frame;

ground wheels for supporting the frame in transport across the ground;

at least one upper connecting link extending from the vehicle frame to the upper frame member;

and two support arms each extending from a front end at the header to a rear end pivotally mounted on the vehicle frame and arranged at a height below the upper link extending from the vehicle frame generally forwardly to the lower frame elements;

each support arm having a respective float spring connected thereto at a pivot thereon forwardly of the rear end and extending therefrom to the vehicle frame for applying a lifting force on the support arm;

each support arm having a pivot connection at the rear end defined by a pivotal link pivotally connected at one end to the vehicle frame and pivotally connected at the other end to the support arm.

### BRIEF DESCRIPTION OF THE DRAWINGS

One embodiment of the invention will now be described in conjunction with the accompanying drawings in which:

FIG. 1 is a side elevational view of a crop harvesting machine according to the present invention showing schematically the forward end of a tractor vehicle and showing schematically the components of the header mounted thereon.

FIG. 2 is a side elevational view of the machine of FIG. 1 on the large scale showing the pivot connection between the rear end of the support arm and the vehicle frame and showing the pivot connection in a normal operating position.

FIG. 3 is a side elevational view similar to that of FIG. 2 showing the pivot connection after an impact of the header with an obstacle in which the pivot connection has operated to absorb the impact forces and to pivot the header upwardly.

FIG. 4 is a cross sectional view along the lines 4-4 of FIG. 3.

In the drawings like characters of reference indicate corresponding parts in the different figures.

### DETAILED DESCRIPTION

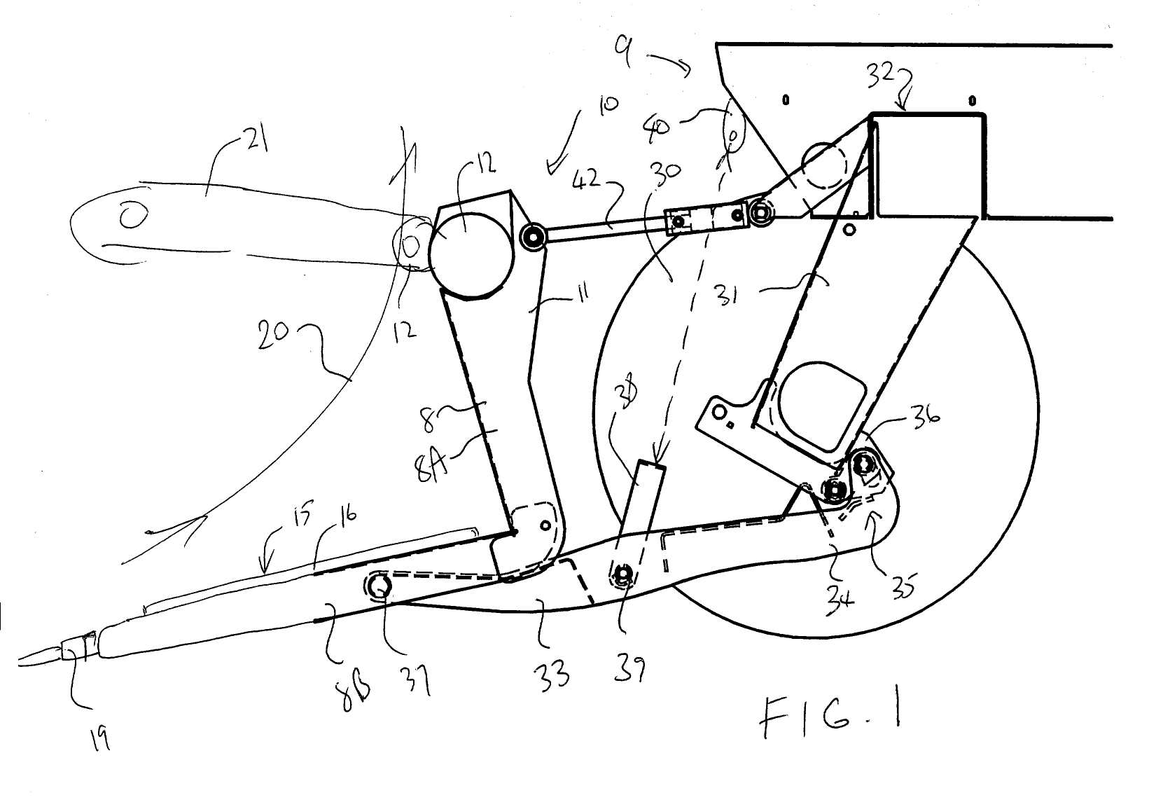

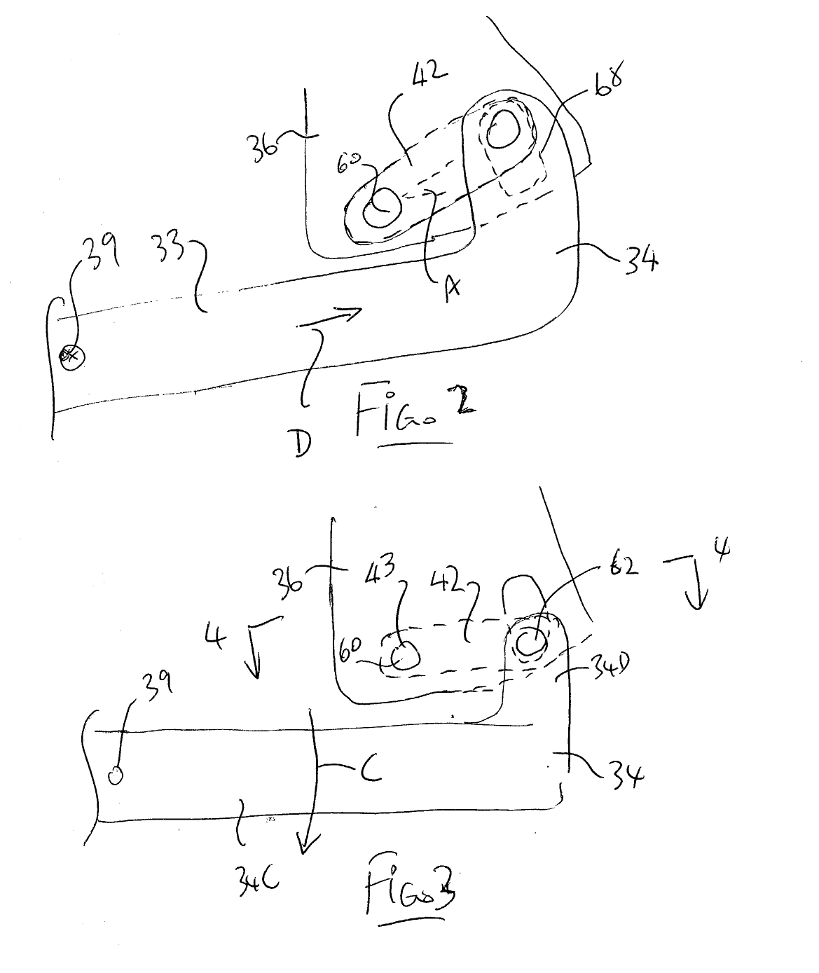

In FIG. 1 is shown an embodiment of a header according to the present invention with a number of the elements being shown schematically since the general construction of such headers is well known to one skilled in the art. The header 10 includes a header frame 11 having a main frame tube 12 extending across the width of the header between two end frames one of which is shown at 13 and the other of which is of course at the other end and therefore not visible in the elevation of FIG. 1. The main tube 12 is suitably supported and attached on a propulsion vehicle in a manner so that the header frame can be moved forwardly across the ground in cutting a standing crop. The end frame 13 extends forwardly from the main tube 12 to a forward nose section 14. The main tube 12 carries a plurality of frame bars which extend downwardly and forwardly for supporting a table 15 of the header onto which crop material is deposited after cutting. The structural elements defining the frame bars on the table are not shown for convenience of illustration since again these are well known to one skilled in the art and can vary in accordance with engineering considerations.

On the table 15 is provided a crop conveyor 16 which is arranged to transport the crop after cutting across the width of a header to a discharge location. In the embodiment shown the conveyor is provided as a draper canvas 17 mounted on rollers 18. Other embodiments can use alternative crop transportation systems and primarily an auger which is commonly used as an alternative for the draper system. The embodiments of the present invention are not limited to either of the different types of header.

At the front of the table 15 is provided a cutter bar generally indicated at 19 which is again only shown schematically since the construction of this is well known to one skilled in the art. The cutter bar shown provides a sickle knife in guards which reciprocates back and forth in a cutting action on the standing crop so that the crop is deposited on the draper for transportation to the discharge location.

When used on a combine harvester the discharge location is associated with a crop transfer system which transfers the crop rearwardly into the feeder house of the combine. Headers of this type can of course also be used as a swather where the discharge location simply discharges the crop onto the ground in a swath or through a crop conditioner onto the ground.

The header further includes a reel generally indicated at 20. The reel 20 includes mounting arms 21 pivoted on a suitable mounting 22 adjacent the tube 12 so that the arms project forwardly from the frame to a position over the end frame elements 13 so as to provide support for the reel extending the header above the cutter bar. Each arm is movable in its pivotal action by a suitable drive actuator 23.

The number of arms can vary in accordance with engineering requirements depending upon the width of the header. Some headers have only arms at the ends and some have additional arms intermediate the ends to provide the necessary support.

The vehicle generally indicated at 9 includes a pair of front wheels 30 each of which is carried on a respective depending leg 31 forming part of a frame structure 32. The front wheel drive generally driven by a hydraulic motor (not shown). The header is mounted on the tractor primarily by a pair of support arms 33. Each of the support arms is pivoted at its rear end 34 by the pivot coupling 35 to a frame element 36 of the leg 31. Each of the support arms has a forward end 37 which engages the header at a position generally underneath the header or the bottom of the arms 8 of the header.

In the conventional header shown where the arms 8 include a generally vertical section 8A and a generally horizontal section 8D, the support arms 33 has the forward end underneath the horizontal section 8D within a channel defining the horizontal section 8B. The support arms are each lifted by a respective lift link 38 which extends from a pivot point 39 on the support arm forwardly of the rear end generally upwardly and rearwardly to a suitable mounting schematically indicated at 40 on the vehicle. The lift link in most cases forms a float spring which carries the majority of the weight of the header leaving a small proportion of the weight of the header to rest on the ground. However the float springs can generally be adjusted so as to carry the header at a raised height where it is required that the cutter bar be spaced from the ground, depending upon crop conditions. One or more upper links 42 is provided between a suitable frame element on the vehicle and an upper part of the frame generally adjacent the tube 12.

Thus the header is mounted on the vehicle by way of the lower support arms and the one or more upper links which allow the header to float upwardly and downwardly and generally to twist about a horizontal axis in the direction of travel. The above general arrangement of header mounting on a tractor is conventional and the improvement herein relates to the construction of the pivot coupling 35 which is arranged in a particular improved manner which has a number of advantages as described herein.

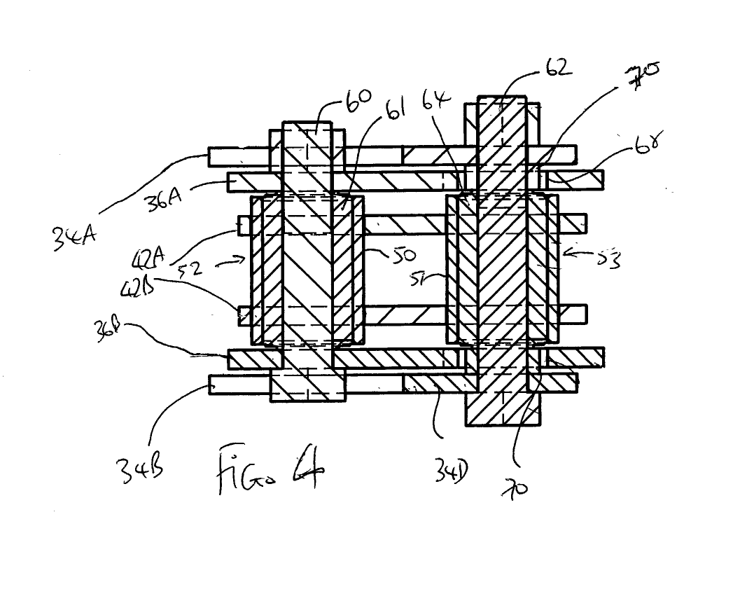

The conventional arrangement by which the rear end 34 of the support arm 33 is connected to the frame is generally a single pivot point defined by a suitable pivot pin. In the present arrangement, however, the single pivot point is replaced by a link 42 which is pivoted at its forward end on the frame element 36 and at its rearward end on the rear end 34 of the arm 33. In general the link 42 is arranged in the normal operating position shown in FIG. 3 so that it is inclined upwardly and rearwardly at an angle A. Thus rearward movement in the direction D of the arm 33 caused by a rearward impact on the cutter bar moves the rear end 34 in the rearward direction which forces the link 42 downwardly and rearwardly as it moves in an arc around the front pivot 43 on the frame 36. This rearward and downward movement of the rear end of the arm 34 causes the arm to pivot about the pivot pin 39 of the float spring in a clockwise direction C. This pivotal movement in the clockwise direction acts to lift the forward end 37 of the support arm causing the header also to be lifted vertically upwardly. In practice the amount of downward movement provided by the pivotal action of the link 42 is of the order of 40 mm providing a vertical lifting movement at the cutter bar of the order of 40 mm.

The construction of the link is best shown in FIG. 4. The arm 34 is thus formed of two side plates 34A and 34B of a channel member with a generally horizontal section 34C and a raised rear section 34D directly at the rear end which extends upwardly from the horizontal section 34C to provide a raised section for receiving the pivot mounting to the link 42. The link 42 is defined by two side plates 42A and 42B which are connected together by the outside tube 50 and 51 of a resilient bushing 52 and 53 respectively. Thus the tubes 50 and 51 and the side plates 42A and 42B form a rigid structure defining the link 42.

The frame section 36 is again defined by two side plates 36A and 36B. The resilient or rubber bushing 52 includes a pin 60 which is connected to the sleeve 50 by a resilient rubber annular connection 61. The pin 60 is clamped between the plates 36A and 36B of the frame member 36. Similarly the side walls 34A and 34B are engaged by a pin 62 which clamps to the side walls 34A and 34B of the rear end of the arm. Thus the resilient bushing 52 defined by the pin 60 and the sleeve 50 allows limited angular pivotal movement of the link 42 relative to the frame 36. Similarly the resilient bushings 53 defined by the sleeve 51 and the pin 62 together with a resilient connection 64 allows limited angular rotation of the link 42 relative to the rear end 34. The total amount of pivotal movement required between the two resilient bushings is a total of the order of 40 degrees and this is automatically balanced between the two resilient bushings since they are generally symmetrical. This reduces the required angular rotation of each of the bushings to an angle of the order of 20 degrees which is well within design limits of resilient bushings of this general type.

The bushings can therefore accommodate both the pivotal movement necessary to recoil and pivot in the impact pivoting action and also can accommodate the necessary general pivotal movement which is provided for the lifting and lowering of the support arms to raise the header to the required position.

The pin 60 is free to move upwardly and downwardly without interference with the arm 33 since it is located above the horizontal section 34C of the arm 33. The pin 62 is free to move upwardly and downwardly relative to the frame 36 since it is located within slots 68 provided in the plates 36A and 36B of the frame 36. The slots are thus arcuate and have a length sufficient to accommodate movement of the pin 62 from its raised initial position at the angle of incline to a position horizontally rearward of the pin 60 in response to the impact. The plates of the frame 36 are held spaced form the plates forming the arm 33 by suitable spacers 70 located on the pin 62.

The pivot link 42 has the advantage that it absorbs impact at the cutter bar and the same time drives the cutter bar upwardly due to the downward movement of the rear end of the support arm.

The pivot link is rubber mounted by the resilient bushings to reduce vibration transmission and to allow some lateral movement of the lower support arm.

The secondary or pivotal link also allows greater pivotal rotation of the lower arm since the rotation is equally split between the two rubber bushings while allowing the use of rubber bushings which are less prone to wear and require less maintenance.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A crop harvesting machine comprising:
a crop harvesting header having:
a header frame structure arranged for movement in a direction of working movement across ground carrying a crop to be harvested;
a crop cutter arranged across the header frame structure for cutting the crop;
the header frame structure including an upper frame member and a plurality of lower frame elements arranged such that an impact on the crop cutter as the header moves forwardly across the ground tends to move the lower frame elements rearwardly;
a transport vehicle for carrying the header across the ground having:
a vehicle frame;
ground wheels for supporting the frame in transport across the ground;
at least one upper connecting link extending from the vehicle frame to the upper frame member;
and a connection between the vehicle frame and at least one of the lower frame elements for providing a lifting force on the header frame, the connection including at least one support arm at a height below the upper link extending from the vehicle frame generally forwardly to the lower frame elements;
the connection between the vehicle frame and the at least one of the lower frame elements being arranged such that an impact on the crop cutter tending to move the lower frame elements rearwardly is absorbed by rearward movement of the header relative to the vehicle and also causes lifting movement of the cutter relative to the ground.

2. The crop harvesting machine according to claim 1 wherein the connection is arranged such that the rearward movement of the header relative to the vehicle causes said lifting movement of the cutter relative to the ground.

3. The crop harvesting machine according to claim 1 wherein the connection includes a linkage which is arranged such that the rearward movement of the linkage causes said lifting movement of the cutter relative to the ground.

4. The crop harvesting machine according to claim 3 wherein the linkage is provided between the at least one support arm and the vehicle frame.

5 The crop harvesting machine according to claim 1 wherein the at least one support arm is mounted on the vehicle frame for pivotal movement upwardly and downwardly about a horizontal pivot axis and wherein there is provided a lift link pivotally connected between the support arm and the vehicle frame for pivoting the at least one support arm in a direction tending to lift a forward end of the at least one support arm and therefore the header carried thereon.

6. The crop harvesting machine according to claim 5 wherein the connection includes a linkage which is arranged such that the rearward movement of the header causes pivotal movement of the at least one support arm generating said lifting movement of the cutter relative to the ground.

7. The crop harvesting machine according to claim 6 wherein the linkage is provided between the at least one support arm and the vehicle frame tending to pivot the support arm about the lift link.

8. The crop harvesting machine according to claim 1 wherein the at least one support arm is pivotally mounted on the vehicle frame at a rear end of the at least one support arm and wherein the lift link is arranged in front of the rear end.

9. The crop harvesting machine according to claim 8 wherein the lift link is a float spring.

10. The crop harvesting machine according to claim 3 wherein the linkage comprises a pivotal link pivotally connected at one end to the vehicle frame and pivotally connected at the other end to the support arm and arranged such that rearward movement of the support arm is taken up by pivotal movement of the link which causes pivotal movement of the support arm.

11. The crop harvesting machine according to claim 10 wherein the pivotal link is pivotally connected to the vehicle frame by a first resilient bushing capable of angularly limited pivotal movement and to the support arm by a second resilient bushing capable of angularly limited pivotal movement and where the pivotal movement of the support arm relative to the vehicle frame is taken up partly by each of the first and second resilient bushings.

11. The crop harvesting machine according to claim 10 wherein the pivotal link is arranged such that, prior to impact forces moving the support arm rearwardly, the link is arranged to extend from the vehicle frame upwardly and rearwardly to the support arm such that rearward movement of the support arm is taken up by rearward movement of the rear end of the link which causes downward movement of the rear end of the link causing downward movement of the rear end of the support arm.

12. A crop harvesting machine comprising:
a crop harvesting header having:
a header frame structure arranged for movement in a direction of working movement across ground carrying a crop to be harvested;
a crop cutter arranged across the header frame structure for cutting the crop;
the header frame structure including an upper frame member and a plurality of lower frame elements arranged such that an impact on the crop cutter as the header moves forwardly across the ground tends to move the lower frame elements rearwardly;
a transport vehicle for carrying the header across the ground having:
a vehicle frame;
ground wheels for supporting the frame in transport across the ground;
at least one upper connecting link extending from the vehicle frame to the upper frame member;
and two support arms each extending from a front end at the header to a rear end pivotally mounted on the vehicle frame and arranged at a height below the upper link extending from the vehicle frame generally forwardly to the lower frame elements;
each support arm having a respective float spring connected thereto at a pivot thereon forwardly of the rear end and extending therefrom to the vehicle frame for applying a lifting force on the support arm;
each support arm having a pivot connection at the rear end arranged such that an impact on the crop cutter tending to move the lower frame elements rearwardly is absorbed by rearward movement of the a support arm relative to the vehicle which rearward movement causes pivotal movement of the support arm relative to the pivot connection to the float spring to effect lifting movement of the cutter relative to the ground.

13. The crop harvesting machine according to claim 12 wherein the pivot comprises a pivotal link pivotally connected at one end to the vehicle frame and pivotally connected at the other end to the support arm and arranged such that rearward movement of the support arm is taken up by pivotal movement of the link which causes pivotal movement of the support arm.

14. The crop harvesting machine according to claim 13 wherein the pivotal link is pivotally connected to the vehicle frame by a first resilient bushing capable of angularly limited pivotal movement and to the support arm by a second resilient bushing capable of angularly limited pivotal movement and where the pivotal movement of the support arm relative to the vehicle frame is taken up partly by each of the first and second resilient bushings.

15. The crop harvesting machine according to claim 13 wherein the pivotal link is arranged such that, prior to impact forces moving the support arm rearwardly, the link is arranged to extend from the vehicle frame upwardly and rearwardly to the support arm such that rearward movement of the support arm is taken up by rearward movement of the rear end of the link which causes downward movement of the rear end of the link causing downward movement of the rear end of the support arm.

16. A crop harvesting machine comprising:
a crop harvesting header having:
a header frame structure arranged for movement in a direction of working movement across ground carrying a crop to be harvested;
a crop cutter arranged across the header frame structure for cutting the crop;
the header frame structure including an upper frame member and a plurality of lower frame elements arranged such that an impact on the crop cutter as the header moves forwardly across the ground tends to move the lower frame elements rearwardly;
a transport vehicle for carrying the header across the ground having:
a vehicle frame;
ground wheels for supporting the frame in transport across the ground;
at least one upper connecting link extending from the vehicle frame to the upper frame member;
and two support arms each extending from a front end at the header to a rear end pivotally mounted on the vehicle frame and arranged at a height below the upper link extending from the vehicle frame generally forwardly to a respective one of the lower frame elements;
each support arm having a respective float spring connected thereto at a pivot thereon forwardly of the rear end and extending therefrom to the vehicle frame for applying a lifting force on the support arm;
each support arm having a pivot connection at the rear end defined by a pivotal link pivotally connected at one end to the vehicle frame and pivotally connected at the other end to the support arm.

17. The crop harvesting machine according to claim 16 wherein the pivotal link is pivotally connected to the vehicle frame by a first resilient bushing capable of angularly limited pivotal movement and to the support arm by a second resilient bushing capable of angularly limited pivotal movement and where the pivotal movement of the support arm relative to the vehicle frame is taken up partly by each of the first and second resilient bushings.

18. The crop harvesting machine according to claim 16 wherein the pivotal link is arranged such that, prior to impact forces moving the support arm rearwardly, the link is arranged to extend from the vehicle frame upwardly and rearwardly to the support arm such that rearward movement of the support arm is taken up by rearward movement of the rear end of the link which causes downward movement of the rear end of the link causing downward movement of the rear end of the support arm.
